(19) United States
(12) Patent Application Publication
(10) Pub. No.: US 2020/0307296 A1
(43) Pub. Date: Oct. 1, 2020

(54) THERMAL TRANSFER IMAGE-RECEIVING SHEET

(71) Applicant: Dai Nippon Printing Co., Ltd., Tokyo (JP)

(72) Inventors: Ryota HATAKEYAMA, Tokyo (JP); Kunihiko SATO, Tokyo (JP)

(73) Assignee: Dai Nippon Printing Co., Ltd., Tokyo (JP)

(21) Appl. No.: 16/954,665

(22) PCT Filed: Mar. 22, 2019
(86) PCT No.: PCT/JP2019/012055

§ 371 Date: Jun. 17, 2020

(30) Foreign Application Priority Data
Mar. 22, 2018 (JP) 2018-054967
Sep. 3, 2018 (JP) 2018-164935

(51) Int. Cl. B41M 5/50

(52) U.S. Cl. CPC B41M 5/504; B41M 5/508; B41M 5/506

(57) ABSTRACT

[Problem] To provide a thermal transfer image-receiving sheet that makes it possible to produce an image-printed item having high smoothness.

[Solution] In a first embodiment of the present invention, a thermal transfer image-receiving sheet is characterized by comprising a receiving layer, a first resin layer, a paper substrate, and a second resin layer in this order, wherein the paper substrate has a thickness of 95 μm or more and 135 μm or less, the first resin layer has a weight of 20 g/m² or more and 60 g/m² or less, the second resin layer has a weight of 19 g/m² or more and 35 g/m² or less.

### TECHNICAL FIELD

The present invention relates to a thermal transfer image-receiving sheet.

### BACKGROUND ART

Various printing methods are conventionally known, and among those, a sublimation type thermal transfer method enables density gradation to be freely adjusted, has excellent reproducibility of neutral colors and of gradation, and makes it possible to form high-quality images comparable to silver halide photographs.

According to this sublimation type thermal transfer method, a thermal transfer sheet having a dye layer comprising a sublimation dye and a thermal transfer image-receiving sheet having a substrate and a receiving layer are superposed onto each other; the thermal transfer sheet is then heated by a thermal head of a thermal transfer printer; the sublimation dye in the dye layer is thus transferred to the receiving layer of the thermal transfer image-receiving sheet to form an image; and accordingly, an image-printed item is obtained.

An image-printed item produced in such a manner needs to have no generated curl, in other words, to have high smoothness so that the grade of the image-printed item can be enhanced. When the image-printed item is placed flatly or pasted on a wall, such a curl becomes particularly conspicuous, resulting in causing the image-printed item to be degraded.

According to Patent Literature 1, a paper substrate is used as a substrate in a thermal transfer image-receiving sheet for cost reduction purposes, but an image-printed item produced using a thermal transfer image-receiving sheet formed in such a manner causes the above-mentioned curl to be markedly generated on the image-printed item.

### CITATION LIST

Patent Literature 1: JP11-277917A

### SUMMARY OF INVENTION

### Technical Problem

Now, the present inventors have obtained findings that a thermal transfer image-receiving sheet comprises a first resin layer, a paper substrate, a second resin layer, and a receiving layer in this order, that such a thermal transfer image-receiving sheet is produced, formed into a roll-shaped test piece, left to stand in a specific environment for a given period of time, and cut into a given size, resulting in causing the test piece to have a curl, and that allowing the paper substrate to have a thickness within a specific value range and adjusting the amount of such a curl within a specific value range can prevent the curl and markedly enhance the smoothness of the image-printed item.

In addition, the present inventors have obtained findings that a thermal transfer image-receiving sheet comprises a first resin layer, a paper substrate, a second resin layer, and a receiving layer in this order, and that allowing the paper substrate to have a thickness within a specific value range and allowing the first resin layer and the second resin layer to have a weight within a specific value range can prevent a curl from being generated on an image-printed item and markedly enhance the smoothness of the image-printed item.

Furthermore, the present inventors have obtained findings that a thermal transfer image-receiving sheet comprises a substrate, a first extrusion polyolefin layer, and a receiving layer in this order, and that adjusting the smoothness of the substrate and the amount of polypropylene comprised in the first extrusion polyolefin layer can prevent a curl from being generated on an image-printed item and markedly enhance the smoothness of the image-printed item.

Thus, a problem to be solved by the present invention is to provide a thermal transfer image-receiving sheet that makes it possible to produce an image-printed item having high smoothness.

### Solution to Problem

In a first embodiment of the present invention, a thermal transfer image-receiving sheet is characterized by comprising a receiving layer, a first resin layer, a paper substrate, and a second resin layer in this order, wherein the paper substrate has a thickness of 95 μm or more and 135 μm or less, the first resin layer has a weight of 20 g/m² or more and 60 g/m² or less, and the second resin layer has a weight of 19 g/m² or more and 35 g/m² or less.

In a second embodiment of the present invention, a thermal transfer image-receiving sheet is characterized by comprising a receiving layer, a first resin layer, a paper substrate, and a second resin layer in this order,
wherein the paper substrate has a thickness of 95 μm or more and 135 μm or less, and
wherein, from the thermal transfer image-receiving sheet,
(1) a test piece having a width of 152 mm is produced,
(2) the test piece is wound up with the receiving layer facing outward, and the wound-off end is taped down, to obtain a roll-shaped test piece having an outer diameter of 60 mm,
(3) the roll-shaped test piece is left to stand in an environment at 35° C. and a relative humidity of 20% for 24 hours,
(4) the roll-shaped test piece is cut by 30 mm from the wound-off end, and
(5) a test piece cut out to have a length of 203 mm from the cut end has a curl, the amount of which is less than 20 mm.

In a third embodiment of the present invention, a thermal transfer image-receiving sheet is characterized by comprising a receiving layer, a first extrusion polyolefin layer, and a substrate, wherein the substrate has a smoothness of 250 seconds or more, and the first extrusion polyolefin layer comprises 65 parts by mass or more of polypropylene with respect to 100 parts by mass of a resin material comprised in the first extrusion polyolefin layer.

In a fourth embodiment of the present invention, a thermal transfer image-receiving sheet is characterized by comprising a receiving layer, a first extrusion polyolefin layer, and a substrate,
wherein the substrate comprises at least coated paper, and
the first extrusion polyolefin layer comprises 65 parts by mass or more of polypropylene with respect to 100 parts by mass of a resin material comprised in the first extrusion polyolefin layer.

### Advantageous Effects of Invention

The present invention can provide a thermal transfer image-receiving sheet that makes it possible to produce an image-printed item having high smoothness.

### BRIEF DESCRIPTION OF DRAWINGS

FIG. 1 is a schematic cross-sectional view of a thermal transfer image-receiving sheet in one embodiment.

FIG. 2 is a schematic cross-sectional view of a thermal transfer image-receiving sheet in one embodiment.

FIG. 3 is a schematic view depicting measurement of the amount of a curl of a thermal transfer image-receiving sheet according to the present invention.

FIG. 4 is a schematic cross-sectional view of a thermal transfer image-receiving sheet in one embodiment.

FIG. 5 is a schematic cross-sectional view of a thermal transfer image-receiving sheet in one embodiment.

FIG. 6 is a view showing an 11-STEP image formed on the receiving layer of the thermal transfer image-receiving sheet in Examples.

FIG. 7 is a view showing a half-black pattern image formed on the receiving layer of the thermal transfer image-receiving sheet in Examples.

### DESCRIPTION OF EMBODIMENTS

(Thermal Transfer Image-Receiving Sheet in First Embodiment)

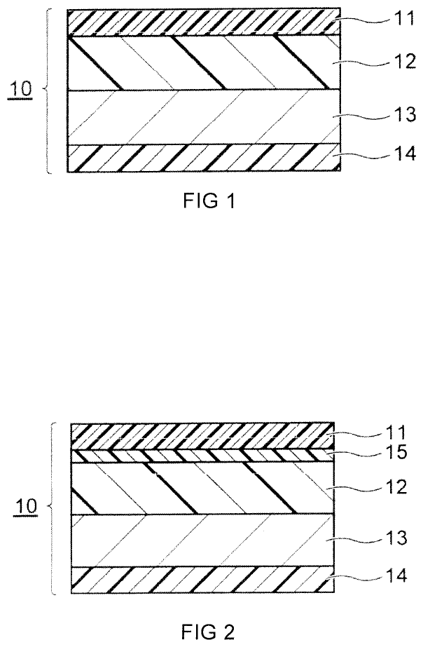

In the first embodiment, a thermal transfer image-receiving sheet 10 according to the present invention comprises a receiving layer 11, a first resin layer 12, a paper substrate 13, and a second resin layer 14 in this order, as shown in FIG. 1.

As used herein, “comprises/comprising . . . in this order” encompasses a case where an intermediate layer 15 is comprised between any two layers, for example, between the first resin layer 12 and the receiving layer 11, as shown in FIG. 2.

Below, each of the layers of the thermal transfer image-receiving sheet in the first embodiment will be described.

(Receiving Layer)

The receiving layer is a layer that receives sublimation dye transferred from a dye layer of the thermal transfer sheet, and retains a formed image, and the receiving layer comprises at least one resin material. Examples of resin materials include polyesters, polyamides, polyolefins, vinyl resins, (meth)acryl resins, imide resins, cellulose resins, styrene resins, polycarbonates, ionomer resins, and the like. Among these, vinyl resins are preferable in terms of enhancing image density and image-printed item storage stability.

The amount of the resin material comprised in the receiving layer is not limited to any particular value, and can be, for example, 80 mass % or more and 98 mass % or less.

In one embodiment, the receiving layer comprises one or more release agents. This can enhance releasability from the thermal transfer sheet after image formation.

Examples of release agents include: solid waxes such as polyethylene waxes, amide waxes, and TEFLON (registered trademark) powder; fluorine-based or phosphate-ester-based surfactants; various modified silicone oils such as silicone oils, reactive silicone oils, and curable silicone oils; and various silicone resins. The above-mentioned silicone oils to be used can also be in the form of oil, and are preferably modified silicone oils. Examples of modified silicone oils that can be preferably used include amino-modified silicones, epoxy-modified silicones, aralkyl-modified silicones, epoxy-aralkyl-modified silicones, alcohol-modified silicones, vinyl-modified silicones, urethane-modified silicones, and the like, and particularly preferable ones are epoxy-modified silicones, aralkyl-modified silicones, and epoxy-aralkyl-modified silicones. The receiving layer can comprise two or more of the above-mentioned release agents. Examples of such release agents include: solid waxes such as polyethylene waxes and amide waxes; fluorine-based surfactants and phosphate-ester-based surfactants; silicone oils, reactive silicone oils, curable silicone oils, and silicone resins; and the like.

The amount of the release agent comprised in the receiving layer is preferably 0.5 mass % or more and 20 mass % or less, more preferably 0.5 mass % or more and 10 mass % or less. This can further enhance releasability from the thermal transfer sheet after image formation.

The receiving layer may comprise a lubricant, ultraviolet absorber, light stabilizer, or antioxidant, if necessary.

A lubricant in the present invention is used to favorably retain the running performance of a thermal transfer ribbon and the like during thermal transfer. The lubricant may be, but is not particularly limited to, any one that does not inhibit the coloring material receptivity of the receiving layer and favorably retains the running performance of a thermal transfer ribbon and the like, and examples of such lubricants include: inorganic lubricants such as calcium carbonate, silica, and barium sulfate; organic lubricants such as polytetrafluoroethylene, polyethylene, waxes (such as fatty acids, aliphatic alcohols, and aliphatic amides), and higher fatty acid metal salts (zinc stearate); and the like. Among these, silica and fatty acid amides are preferably used.

In addition, the receiving layer can comprise an additive such as a release agent, plasticizer, filler, ultraviolet stabilizer, color protection agent, surfactant, fluorescent whitener, delusterant, deodorant, flame retardant, weathering agent, antistatic agent, yarn friction reducer, slip agent, antioxidant, ion exchanger, dispersant, ultraviolet absorber, or colorant such as pigment or dye to the extent that the characteristics of the present invention are not impaired.

The receiving layer preferably has a thickness of 0.5 μm or more and 20 μm or less, more preferably 1 μm or more and 10 μm or less. This can further enhance the smoothness and standing curl preventiveness of a produced image-printed item. In addition, this can further enhance the density of an image formed on the receiving layer.

In addition, the receiving layer preferably has a weight of 0.4 g/m² or more and 16 g/m² or less, more preferably 0.8 g/m² or more and 8 g/m² or less. This can further enhance the smoothness and standing curl preventiveness of a produced image-printed item.

The receiving layer can be formed by dispersing or dissolving the above-mentioned materials in water or a suitable solvent to obtain a coating liquid, applying this coating liquid to the first resin layer or the intermediate layer by a known means such as a roll coating method, reverse roll coating method, gravure coating method, reverse gravure coating method, bar coating method, or rod coating method to form a coating film, and then drying the coating film.

(First Resin Layer)

In the first embodiment, the first resin layer of the thermal transfer image-receiving sheet has a weight of 20 g/m² or more and 60 g/m² or less. In terms of the smoothness and standing curl preventiveness of an image-printed item, the first resin layer preferably has a weight of 25 g/m² or more and 60 g/m² or less, more preferably 30 g/m² or more and 55 g/m² or less.

In the present invention, the weight of each layer can be measured, for example, after the thermal transfer image-receiving sheet is immersed in a sodium hydroxide solution, followed by peeling each layer.

The first resin layer comprises at least one resin material, and examples of such resin materials include polyesters, polyamides, polyolefins, vinyl resins, (meth)acryl resins, imide resins, cellulose resins, styrene resins, polycarbonates, ionomer resins, and the like. Among these, polyolefins are preferable in terms of the smoothness and standing curl preventiveness of a produced image-printed item, and polypropylene is particularly preferable in terms of image density.

The first resin layer is preferably a non-porous layer, which can further enhance the standing curl preventiveness.

In the present invention, the non-porous layer refers to a layer having a porosity of 5% or less.

In the present invention, the porosity is determined by analyzing the cross-sectional SEM image of the first resin layer using an image analysis software, ImageJ, and then dividing the area of the void portion by the area of both the void portion and the resin portion. Specifically, the image analysis software binarizes the cross-sectional SEM image, affording a distribution chart showing the void portion as a black region, and thus, the porosity can be measured by determining the ratio of the black region to the cross-sectional area.

The amount of the resin material comprised in the first resin layer is preferably 30 mass % or more and 100 mass % or less, more preferably 50 mass % or more and 100 mass % or less. This can further enhance the smoothness and standing curl preventiveness of a produced image-printed item.

The first resin layer preferably comprises a thermoplastic elastomer, thus making it possible to prevent generation of printing nonuniformity in an image formed on the receiving layer, and to enhance the density of the image.

Examples of thermoplastic elastomers include: olefin elastomers such as ethylene-propylene copolymers, ethylene-butene copolymers, ethylene-hexene copolymers, ethylene-octene copolymers, ethylene-decene copolymers, propylene-butene copolymers, propylene-butene-ethylene copolymers, and ethylene-propylene-diene copolymers; styrene elastomer such as urethane elastomers, ester elastomers, styrene-butadiene block copolymers, styrene-butadiene-styrene copolymers, styrene-isoprene-styrene copolymers, styrene-ethylene-butene-styrene copolymers, and styrene-ethylene-propylene-styrene copolymers; amide elastomers; (meth)acryl elastomers; and vinyl elastomers.

Among these, styrene-ethylene-butene-styrene copolymers and olefin elastomers (particularly polypropylene elastomers) are preferable.

The thermoplastic elastomer preferably has a thermal conductivity of 0.8 w/m·K or less, preferably 0.6 w/m·K or less.

In addition, the thermoplastic elastomer preferably has a hardness of 40 or less, more preferably 35 or less.

In the present invention, the hardness is measured in accordance with JIS K 6253 (2012 issue).

The amount of the thermoplastic elastomer comprised in the first resin layer is preferably 5 mass % or more and 50 mass % or less, more preferably 10 mass % or more and 40 mass % or less. This can more effectively prevent generation of printing nonuniformity and further enhance the density of an image.

The first resin layer can comprise any of the above-mentioned additives to the extent that the characteristics of the present invention are not impaired.

The first resin layer preferably has a thickness of 5 μm or more and 100 μm or less, more preferably 10 μm or more and 70 μm or less, still more preferably 30 μm or more and 60 μm or less. This can further enhance the smoothness and standing curl preventiveness of a produced image-printed item.

In one embodiment, the first resin layer is an extrusion resin layer, and can be formed by allowing a mixture comprising the above-mentioned materials to be melt-extruded onto the paper substrate or the like.

In another embodiment, the first resin layer can be formed by dispersing or dissolving the above-mentioned materials in water or a suitable solvent to obtain a coating liquid, applying this coating liquid to the paper substrate by a known means such as a roll coating method, reverse roll coating method, gravure coating method, reverse gravure coating method, bar coating method, or rod coating method to form a coating film, and then drying the coating film.

(Paper Substrate)

In the first embodiment, the paper substrate of the thermal transfer image-receiving sheet has a thickness of 95 μm or more and 135 μm or less. In terms of the smoothness and standing curl preventiveness of an image-printed item, the paper substrate preferably has a thickness of 105 μm or more and 133 μm or less, more preferably 110 μm or more and 130 μm or less.

Examples of paper substrates that can be used include: coating paper such as art paper, coated paper, matt coated paper, resin-coated paper, cast-coated paper, kraft paper, and baryta paper; high-quality paper, medium-grade paper, paperboard, impregnated paper, vapor-deposition paper, acid paper, and neutralized paper; and the like.

Among these, coating paper is preferable, and coated paper is more preferable, in terms of achieving dimensional stability and a decrease in ununiformity.

The paper substrate preferably has a basis weight of 110 g/m² or more and 160 g/m² or less, more preferably 130 g/m² or more and 150 g/m² or less, in terms of the smoothness of a produced image-printed item.

In addition, an image-printed item produced using a thermal transfer image-receiving sheet including a paper substrate as a substrate is susceptible to the influence of the ambient environment, and, for example, results in generating a curl over time when left to stand in a high-humidity environment (hereinafter, such a curl is referred to as a standing curl).

Allowing the paper substrate to have a basis weight within the above-mentioned value range effectively prevents generation of a standing curl of the image-printed item (hereinafter, referred to as standing curl preventiveness).

(Second Resin Layer)

In the first embodiment, the second resin layer of the thermal transfer image-receiving sheet has a weight of 19 g/m² or more and 35 g/m² or less. In terms of the smoothness and standing curl preventiveness of an image-printed item, the second resin layer preferably has a weight of 21 g/m² or more and 30 g/m² or less.

The second resin layer comprises at least one resin material, and examples of such resin materials include polyesters such as polyethylene terephthalate (PET), polybutylene terephthalate (PBT), polyethylene naphthalate (PEN), 1,4-polycyclohexylene dimethylene terephthalate, and terephthalic acid-cyclohexanedimethanol-ethylene glycol copolymers; polyamides such as nylon 6 and nylon 6,6; polyolefins such as polypropylene (PP), polyethylene (PE), and polymethylpentene; vinyl resins such as polyvinyl chloride, polyvinyl alcohol (PVA), polyvinyl acetate, vinyl chloride-vinyl acetate copolymers, polyvinylbutyral, and polyvinylpyrrolidone (PVP); (meth)acryl resins such as polyacrylate, polymethacrylate, and polymethylmethacrylate; imide resins such as polyimides and polyetherimides; cellulose resins such as cellophane, cellulose acetate, nitrocellulose, cellulose acetate propionate (CAP), and cellulose acetate butyrate (CAB); styrene resins such as polystyrene (PS); polycarbonate; ionomer resins; and the like.

Among these, polyolefins are preferable, and polyethylene is particularly preferable, in terms of the smoothness of a produced image-printed item.

Allowing the second resin layer to comprise a polyolefin can enhance the standing curl preventiveness.

In the present invention, “(meth)acrylate” means encompassing both “acrylate” and “methacrylate”.

The amount of the resin material comprised in the second resin layer is preferably 30 mass % or more and 100 mass % or less, more preferably 50 mass % or more and 100 mass % or less. This can further enhance the smoothness and standing curl preventiveness of a produced image-printed item.

The second resin layer can comprise any of the above-mentioned additives to the extent that the characteristics of the present invention are not impaired.

The second resin layer preferably has a thickness of 5 μm or more and 100 μm or less, more preferably 10 μm or more and 70 μm or less, still more preferably 20 μm or more and 40 μm or less. This can further enhance the smoothness and standing curl preventiveness of a produced image-printed item.

In one embodiment, the second resin layer is an extrusion resin layer, and can be formed by allowing a mixture comprising the above-mentioned materials to be melt-extruded onto the paper substrate or the like.

In another embodiment, the second resin layer can be formed by dispersing or dissolving the above-mentioned materials in water or a suitable solvent to obtain a coating liquid, applying this coating liquid to the paper substrate by a known means such as a roll coating method, reverse roll coating method, gravure coating method, reverse gravure coating method, bar coating method, or rod coating method to form a coating film, and then drying the coating film.

(Intermediate layer)

In one embodiment, a thermal transfer image-receiving sheet according to the present invention has an intermediate layer between any two layers, for example, between the receiving layer and the first resin layer. The intermediate layer has one or more abilities such as solvent resistance, barrier properties, adhesiveness, whitening properties, masking properties, cushioning properties, and antistatic properties.

A thermal transfer image-receiving sheet according to the present invention may have two or more intermediate layers. The two or more intermediate layers may have the same or different abilities.

The intermediate layer can comprise a resin material such as a polyolefin, vinyl resin, (meth)acryl resin, cellulose resin, polyester, polyamide, polycarbonate, sulfone resin, epoxy resin, polyurethane, vinyl resin, styrene resin, imide resin, or ionomer resin. The intermediate layer can comprise two or more of the above-mentioned resin materials.

In one embodiment, the intermediate layer comprises a filler such as titanium oxide, zinc oxide, magnesium carbonate, or calcium carbonate. Allowing the intermediate layer to comprise such a filler enables masking properties to be imparted to the intermediate layer, wherein the masking properties mask nonuniformity or the like of the substrate.

In addition, such an intermediate layer results in having whitening properties, enabling a clearer image to be formed on the receiving layer.

In one embodiment, the intermediate layer comprises an antistatic agent. Examples of antistatic agents include anionic surfactants, cationic surfactants, nonionic surfactants, amphoteric surfactants, and the like.

Examples of anionic surfactants include: carboxylic salts such as N-acyl carboxylic salts, ether carboxylic salts, and aliphatic amine salts; sulfonic salts such as sulfosuccinic salts, ester sulfonic salts, and N-acyl sulfonic salts; sulfuric ester salts such as sulfuric ester salts, alkylsulfuric salts, sulfuric ether salts, and sulfuric amide salts; phosphoric ester salts such as alkylphosphoric salts, phosphoric ether salts, and phosphoric amide salts; and the like.

Examples of cationic surfactants include: amine salts such as alkylamine salts; quaternary ammonium salts such as alkyltrimethylammonium chloride; alkyl imidazoline derivatives such as 1-hydroxyethyl-2-alkyl-2-imidazoline; imidazolinium salts; pyridinium salts; isoquinolinium salts; and the like.

Examples of nonionic surfactants include: ethers such as alkylpolyoxyethylene ether and p-alkylphenylpolyoxyethylene ether; fatty acid sorbitan polyoxyethylene ether, fatty acid sorbitolpolyoxyethylene ether, fatty acid glycerin polyoxyethylene ether, fatty acid polyoxyethylene ester, monoglyceride, diglyceride, sorbitan ester, sucrose ester, divalent alcohol ester, borate dialcohol alkylamine, dialcohol alkylamine ester, fatty acid alkanolamide, N,N-di(polyoxyethylene)alkane amide, alkanolamine ester, N,N-di(polyoxyethylene)alkane amine, amine oxide, alkylpolyethylene imine, and the like.

Examples of amphoteric surfactants include monoamino carboxylic acid, polyamino carboxylic acid, N-alkyl amino propionic salt, N,N-di(carboxyethyl)alkyl amine salt, and the like.

Without limitation to the above-mentioned surfactants, examples of antistatic agents that may be used include layered silicic salts, cationic (meth)acryl resins, and polyanilines.

In one embodiment, the intermediate layer comprises a fluorescent whitener such as a stilbene compound, benzimidazole compound, and benzoxazole compound. The intermediate layer comprising a fluorescent whitener results in having whitening properties, making it possible to produce an image-printed item having a clearer image.

The intermediate layer can comprise any of the above-mentioned additives to the extent that the characteristics of the present invention are not impaired.

In addition, the intermediate layer preferably has a weight of 0.05 g/m² or more and 5 g/m² or less, more preferably 0.1 g/m² or more and 3 g/m² or less. This can further enhance the smoothness and standing curl preventiveness of a produced image-printed item.

The thickness of the intermediate layer is preferably changed suitably in accordance with the required abilities, and, for example, can be 0.1 μm or more and 3 μm or less.

The intermediate layer can be formed by dispersing or dissolving the above-mentioned materials in water or a suitable solvent to obtain a coating liquid, applying this coating liquid to the first resin layer and the like by a known means such as a roll coating method, reverse roll coating method, gravure coating method, reverse gravure coating method, bar coating method, or rod coating method to form a coating film, and then drying the coating film.

(Thermal Transfer Image-Receiving Sheet in Second Embodiment)

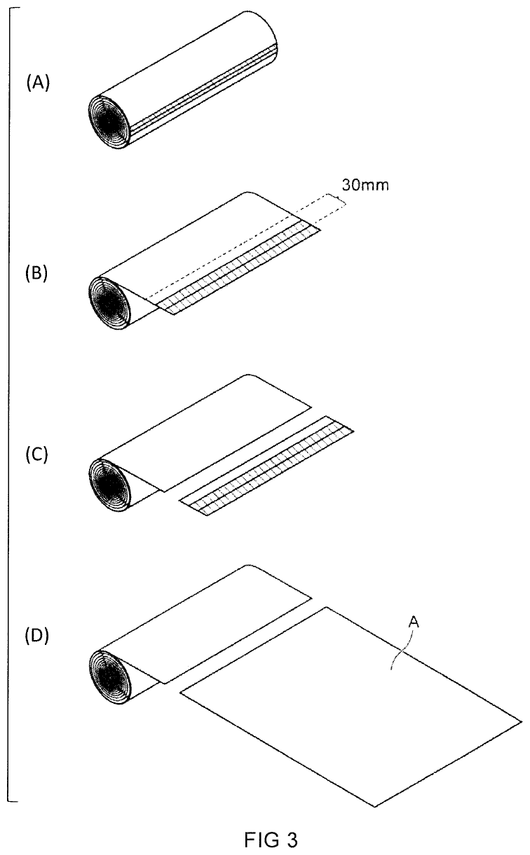

In this embodiment, a thermal transfer image-receiving sheet is such that, from the thermal transfer image-receiving sheet,
(1) a test piece having a width of 152 mm is produced,
(2) the test piece is wound up with the receiving layer facing outward, and the wound-off end is taped down, to obtain a roll-shaped test piece having an outer diameter of 60 mm (see FIG. 3(A); the hatched-line-shaded portion shows the taped-down portion),
(3) the roll-shaped test piece is left to stand in an environment at 35° C. and a relative humidity of 20% for 24 hours,
(4) the roll-shaped test piece is cut by 30 mm from the wound-off end (see FIGS. 3(B) and 3(C)), and
(5) a test piece is cut out to have a length of 203 mm from the cut end, and the resulting test piece A (see FIG. 3(D)) has a curl, the amount of which is less than 20 mm, preferably less than 10 mm. This can further enhance the smoothness of a produced image-printed item.

In the present invention, the taped-down portion is provided so as not to be more than 30 mm from the wound-off end, as shown in FIG. 3(B), and the taped-down portion provided on the body of the roll-shaped test piece is also cut together.

In addition, the taped-down portion is provided wholly along the width direction in some cases, and provided partially along the width direction in other cases.

In this regard, the taped-down portion is cut off because the force applied to the portion in a wound-up state is different from the force applied to the other portion.

In this embodiment, a thermal transfer image-receiving sheet is such that, from the thermal transfer image-receiving sheet,
(1) a test piece having a width of 152 mm is produced,
(2) the test piece is wound up with the receiving layer facing outward, and the wound-off end is taped down, to obtain a roll-shaped test piece having an outer diameter of 60 mm,
(3) the roll-shaped test piece is left to stand in an environment at 35° C. and a relative humidity of 20% for 24 hours,
(4) the roll-shaped test piece is cut by 30 mm from the wound-off end, and
(5) an image is formed on the receiving layer of the roll-shaped test piece to produce an image-printed item having a size 152 mm in width and 203 mm in length from the cut end, and the amount of a curl of the produced image-printed item is preferably less than 5 mm, more preferably less than 3 mm.

In measurement of the amount of a curl, the image formed is a solid white image, a thermal transfer printer used does not have a decurling unit, and the image-printing mode is set to the gloss mode.

In this regard, some printers cut the wound-off end of the roll-shaped thermal transfer image-receiving sheet by a given length in one of the initialization operations, and it should accordingly be noted that, in cases where such an operation is applied, the test piece needs to be made longer by the length to be cut off.

The layered constituents of the second thermal transfer image-receiving sheet are the same as those of the thermal transfer image-receiving sheet in the first embodiment, and here, the description of the layered constituents is omitted.

Below, each of the layers of the thermal transfer image-receiving sheet in the second embodiment will be described, but the constituents of the receiving layer and those of a primer are each the same as those in the first embodiment, and here, the description of the constituents is omitted.

(First Resin Layer)

In the second embodiment, the first resin layer of the thermal transfer image-receiving sheet preferably has a weight of 20 g/m² or more and 60 g/m² or less, more preferably 35 g/m² or more and 55 g/m² or less. This can further enhance the smoothness and standing curl preventiveness of a produced image-printed item.

The other constituents, such as the materials comprised in the first resin layer and the thickness of the layer, are the same as those for the thermal transfer image-receiving sheet in the first embodiment, and here, the description of the constituents is omitted.

(Paper Substrate)

In the second embodiment, the paper substrate of the thermal transfer image-receiving sheet has a thickness of 95 μm or more and 135 μm or less, and, in terms of the smoothness and standing curl preventiveness of a produced image-printed item, the paper substrate preferably has a thickness of 105 μm or more and 133 μm or less, more preferably 110 μm or more and 130 μm or less.

The other constituents, such as usable paper substrates and basis weights, are the same as those for the thermal transfer image-receiving sheet in the first embodiment, and here, the description of the constituents is omitted.

(Second Resin Layer)

In the second embodiment, the second resin layer preferably has a weight of 19 g/m² or more and 35 g/m² or less, more preferably 21 g/m² or more and 30 g/m² or less. This can further enhance the smoothness and standing curl preventiveness of a produced image-printed item.

The other constituents, such as the materials comprised in the second resin layer and the thickness of the layer, are the same as those for the thermal transfer image-receiving sheet in the first embodiment, and here, the description of the constituents is omitted.

(Thermal Transfer Image-Receiving Sheet in Third Embodiment)

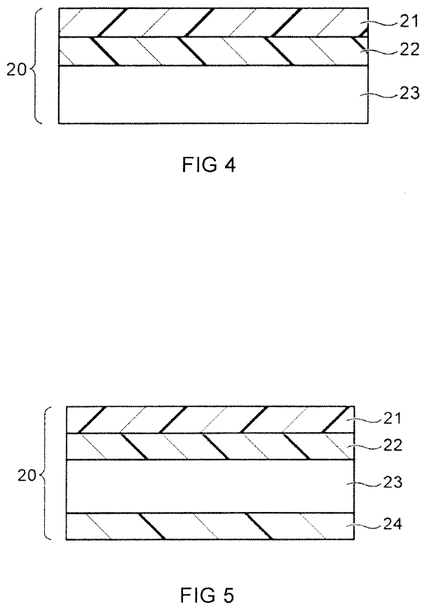

In the third embodiment, a thermal transfer image-receiving sheet 20 comprises a receiving layer 21, a first extrusion polyolefin layer 22, and a substrate 23, as shown in FIG. 4.

In one embodiment, the thermal transfer image-receiving sheet 20 according to the present invention comprises a second extrusion polyolefin layer 24 on the opposite side of the substrate 23 from the first extrusion polyolefin layer 22 side, as shown in FIG. 5.

In one embodiment, the thermal transfer image-receiving sheet 20 in the third embodiment has an intermediate layer (not shown) between any two layers, for example, between the receiving layer 21 and the first extrusion polyolefin layer 22.

The thermal transfer image-receiving sheet in the third embodiment can enhance the smoothness of the image-printed item and in addition, enhance the density of an image formed on the receiving layer and the printing nonuniformity preventiveness.

In addition, the thermal transfer image-receiving sheet makes it possible to effectively prevent generation of wrinkles on the surface of the receiving layer during storage of the sheet in wound-up form (hereinafter, referred to as winding-caused-wrinkle preventiveness).

Furthermore, the thermal transfer image-receiving sheet makes it possible to prevent heat of the thermal head during image formation from generating steps and roughness (what is called embossments) on the receiving layer (hereinafter referred to as embossment preventiveness).

Below, each of the layers of the thermal transfer image-receiving sheet in the third embodiment will be described, but the constituents of the receiving layer are the same as those in the first embodiment, and here, the description of the constituents is omitted.

(First Extrusion Polyolefin Layer)

The first extrusion polyolefin layer comprises polypropylene, the amount of which is 65 mass % or more. In addition, the amount is more preferably 75 mass % or more, still more preferably 85 parts by mass or more, in terms of the capability to further enhance the density of an image formed on the receiving layer and the printing nonuniformity generation preventiveness.

The first extrusion polyolefin layer may comprise a resin material other than polypropylene (hereinafter referred to as (an)other resin material(s)) to the extent that the characteristics of the present invention are not impaired, and examples of such other resin materials include polyesters such as polyethylene terephthalate (PET), polybutylene terephthalate (PBT), polyethylene naphthalate (PEN), 1,4-polycyclohexylene dimethylene terephthalate, and terephthalic acid-cyclohexanedimethanol-ethylene glycol copolymers; polyamides such as nylon 6 and nylon 6,6; polyolefins such as high-density polyethylene (HDPE, having a density of 0.941 g/cm³ or more), medium-density polyethylene (MDPE, having a density of 0.925 g/cm³ or more and less than 0.941 g/cm³), low-density polyethylene (LDPE, having a density of less than 0.925 g/cm³), linear low-density polyethylene (LLDPE, having a density of less than 0.925 g/cm³), and polymethylpentene; vinyl resins such as polyvinyl chloride, polyvinyl alcohol (PVA), polyvinyl acetate, vinyl chloride-vinyl acetate copolymers, polyvinylbutyral, and polyvinylpyrrolidone (PVP); (meth)acryl resins such as polyacrylate, polymethacrylate, and polymethylmethacrylate; polyimides such as polyimides and polyetherimides; cellulose resins such as cellophane, cellulose acetate, nitrocellulose, cellulose acetate propionate (CAP), and cellulose acetate butyrate (CAB); polystyrene; polycarbonate; ionomer resins; and the like. Among these, polyolefins are preferable, because polyolefins can enhance the density of an image formed on the receiving layer and the printing nonuniformity generation preventiveness.

In the present invention, “(meth)acrylate” encompasses both “acrylate” and “methacrylate”.

The amount of the (an)other resin material(s) comprised in the first extrusion polyolefin layer is preferably 30 mass % or less, more preferably 20 mass % or less, still more preferably 10 mass % or less. This can further enhance the density of an image formed on the receiving layer and the printing nonuniformity generation preventiveness.

The first extrusion polyolefin layer preferably comprises any of the above-mentioned thermoplastic elastomers, thus making it possible to prevent generation of printing nonuniformity in an image formed on the receiving layer, and to enhance the density of the image.

The amount of the thermoplastic elastomer comprised in the first extrusion polyolefin layer is preferably 5 mass % or more and 50 mass % or less, more preferably 10 mass % or more and 40 mass % or less. This can more effectively prevent generation of printing nonuniformity and further enhance the density of an image.

The first extrusion polyolefin layer can comprise any of the above-mentioned additives such as a release agent, plasticizer, filler, ultraviolet stabilizer, color protection agent, surfactant, fluorescent whitener, delusterant, deodorant, flame retardant, weathering agent, antistatic agent, yarn friction reducer, slip agent, antioxidant, ion exchanger, dispersant, ultraviolet absorber, and colorant such as pigment or dye to the extent that the characteristics of the present invention are not impaired.

The first extrusion polyolefin layer preferably has a thermal conductivity of 0.25 W/m·K or less. This can further enhance the density of an image formed on the receiving layer. In addition, the first extrusion polyolefin layer more preferably has a thermal conductivity of 0.23 W/m·K or less, still more preferably 0.18 W/m·K or less.

In the present invention, the thermal conductivity of the first extrusion polyolefin layer is measured in accordance with ASTM C 177-04.

The first extrusion polyolefin layer preferably has a thickness of 5 μm or more and 100 μm or less, more preferably 10 μm or more and 60 μm or less, still more preferably 20 μm or more and 45 μm or less. Allowing the first extrusion polyolefin layer to have a thickness within these value ranges can further enhance the printing nonuniformity generation preventiveness and the embossment generation preventiveness.

The first extrusion polyolefin layer can be formed by allowing a mixture comprising the above-mentioned resin materials to be melt-extruded onto the substrate.

(Substrate)

In the third embodiment, the substrate has a smoothness of 250 seconds or more, which can enhance the smoothness of an image-printed item. The substrate more preferably has a smoothness of 270 seconds or more, still more preferably 290 seconds or more.

In the present invention, the smoothness is measured in accordance with JIS P 8155 (2010 issue) using an Oken type air-permeability & smoothness tester (EB65, manufactured by Asahi Seiko Co., Ltd.).

In addition, the substrate needs to have a heat resistance that can withstand thermal energy applied during thermal transfer (for example, heat of a thermal head), and needs to have a mechanical strength that can support a receiving layer and the like provided on the substrate. Examples of such substrates that can be used include: paper substrates such as high-quality paper, art paper, coated paper, resin-coated paper, cast-coated paper, paperboard, synthetic paper, and impregnated paper; and films formed of a resin material such as a polyester, polyamide, polyolefin, vinyl resin, or (meth)acryl resin (hereinafter, simply referred to as a “resin film”).

Among these, high-quality paper and coated paper are preferable, and coated paper is particularly preferable, in terms of the smoothness of an image-printed item.

In addition, a laminate composed of the above-mentioned paper substrate alone, a laminate composed of a resin film alone, or a laminate composed of a paper substrate and a resin film can be used as a substrate.

These laminates can be produced by utilizing a dry lamination method, wet lamination method, extrusion method, or the like.

The substrate preferably has a thickness of 100 μm or more and 200 μm or less, more preferably 120 μm or more and 170 μm or less.

(Second Extrusion Polyolefin Layer)

In one embodiment, a thermal transfer image-receiving sheet according to the present invention comprises a second extrusion polyolefin layer on the opposite side from a first extrusion polyolefin layer side.

The second extrusion polyolefin layer comprises any of the above-mentioned polyolefins, and preferably comprises, among the polyolefins, one or more of polypropylene, high-density polyethylene, medium-density polyethylene, low-density polyethylene, and linear low-density polyethylene, in terms of the smoothness of an image-printed item.

The amount of polyolefin comprised in the second extrusion polyolefin layer is preferably changed suitably, taking into consideration the constituents of the first extrusion polyolefin layer, and can be, for example, 70 mass % or more.

The second extrusion polyolefin layer may comprise any of the above-mentioned other resin materials to the extent that the characteristics of the present invention are not impaired. In addition, the amount is preferably 20 parts by mass or less, more preferably 10 parts by mass or less, with respect to 100 parts by mass of the total of the solids in the layer, in terms of the capability to further enhance the smoothness of an image-printed item and the winding-caused-wrinkle preventiveness.

In addition, the second extrusion polyolefin layer can comprise any of the above-mentioned additives to the extent that the characteristics of the present invention are not impaired.

The thickness of the second extrusion polyolefin layer is preferably changed suitably, taking into consideration the constituents of the first extrusion polyolefin layer, and can be, for example, 5 μm or more and 100 μm or less.

The second extrusion polyolefin layer can be formed by allowing a mixture comprising the above-mentioned resin materials to be melt-extruded onto the substrate.

(Intermediate layer)

In one embodiment, a thermal transfer image-receiving sheet according to the present invention comprises an intermediate layer between the substrate and the receiving layer. The intermediate layer has one or more abilities such as solvent resistance, barrier properties, adhesiveness, whitening properties, masking properties, cushioning properties, and antistatic properties.

A thermal transfer image-receiving sheet according to the present invention may comprise two or more intermediate layers. The two or more intermediate layers may have the same or different abilities. The constituents of the intermediate layer are above-mentioned, and here, the description of them is omitted.

(Thermal Transfer Image-Receiving Sheet in Fourth Embodiment)

In the fourth embodiment, a thermal transfer image-receiving sheet is characterized by comprising a receiving layer, a first extrusion polyolefin layer, and a substrate comprising at least coated paper. In another embodiment, a thermal transfer image-receiving sheet according to the present invention comprises a second extrusion polyolefin layer on the opposite side of a substrate from a first extrusion polyolefin layer side.

In another embodiment, a thermal transfer image-receiving sheet in the second embodiment has an intermediate layer (not shown) between the substrate and the receiving layer.

The layers of the thermal transfer image-receiving sheet in the third embodiment are the same as those of the thermal transfer image-receiving sheet in the fourth embodiment except for the substrate, and here, the description of the layers is omitted.

(Substrate) In the fourth embodiment, the substrate of the thermal transfer image-receiving sheet according to the present invention comprises at least coated paper.

The substrate preferably has a smoothness of 250 seconds or more, more preferably 270 seconds or more, still more preferably 290 seconds or more. This can enhance the smoothness of an image-printed item.

In addition, the substrate in the fourth embodiment may be a laminate of coated paper and another paper substrate or a resin film.

The substrate preferably has a thickness of 100 μm or more and 200 μm or less, more preferably 120 μm or more and 170 μm or less. This can further prevent generation of a curl of an image-printed item.

In the present DESCRIPTION, the resins and the like which are each formed into each layer are described illustratively, and these resins may each be: a homopolymer of a monomer to be included in each resin; a copolymer of a monomer to be included as a main component in each resin and one or more other monomers; or a derivative thereof. For example, an acryl resin mentioned herein needs only to comprise, as a main component, an acrylic acid, a monomer of a methacrylic acid, an acrylate, or a monomer of a methacrylate. Alternatively, the acryl resin may be a modified product of any of these resins. Alternatively, any resin other than mentioned in the present DESCRIPTION may be used.

### EXAMPLES

Next, the present invention will be further described in detail with reference to Examples, but the present invention is not limited to these Examples.

### Example 1-1

A paper substrate A (NEVIA; manufactured by GOLD EAST PAPER (JIANGSU) CO., LTD; having a basis weight of 120 g/m²) having a thickness of 98 μm was prepared, and a resin composition A (having a density of 0.948 g/cm³) obtained by mixing a high-density polyethylene (NOVATEC (registered trademark) HD HS471; manufactured by Japan Polyethylene Corporation; having a density of 0.956 g/cm³) and a low-density polyethylene (NOVATEC (registered trademark) LD LC600A; manufactured by Japan Polyethylene Corporation; having a density of 0.918 g/cm³) at a ratio of 8:2 was melt-extruded on one side of the paper substrate A to form a second resin layer having a weight of 26 g/m² and a thickness of 28 μm.

A resin composition B (having a density of 0.898 g/cm³) obtained by mixing a polypropylene (PHAO3A; manufactured by SunAllomer Ltd.; having a density of 0.9 g/cm³) and a styrene-ethylene-butene-styrene copolymer (TUFTEC (registered trademark) H1052; manufactured by Asahi Kasei Corporation; having a density of 0.89 g/cm³) at a ratio of 8:2 was melt-extruded on the other side of the paper substrate to form a first resin layer having a weight of 45 g/m² and a thickness of 50 μm.

The tensile modulus of the first resin layer was 900 MPa as measured in accordance with JIS K 6921-2.

A coating liquid for an intermediate layer having the following composition was applied to the first resin layer using a bar coater so that the intermediate layer could have a thickness of 2 μm when dried. The coating liquid was dried to form the intermediate layer.

<Coating liquid for intermediate layer>
Polyester: 50 parts by mass
   (POLYESTER (registered trademark) WR-905; manufactured by Nippon Synthetic Chemical Industry Co., Ltd.)
Titanium oxide: 20 parts by mass
   (TCA888; manufactured by Tochem Products Co., Ltd.)
Fluorescent whitener: 1.2 parts by mass
   (Uvitex (registered trademark) BAC; manufactured by Ciba Specialty Chemicals Inc.)
Water: 14.4 parts by mass
Isopropanol (IPA): 14.4 parts by mass

Next, a coating liquid that has the following composition and is used to form a receiving layer was applied to the intermediate layer so that the amount of application could be 2.5 g/m² when the coating liquid was dried. The coating liquid was dried to form a receiving layer having a thickness of 3.1 μm, and thus, a thermal transfer image-receiving sheet was obtained.

<Coating liquid for forming receiving layer>
Vinyl chloride-vinyl acetate copolymer: 60 parts by mass
   (SOLBIN (registered trademark) C, manufactured by Nissin Chemical Co., Ltd.)
Epoxy-modified silicone: 1.2 parts by mass
   (X-22-3000T, manufactured by Shin-Etsu Chemical Co., Ltd.)
Methylstyl-modified silicone resin: 0.6 parts by mass
   (X-24-510, manufactured by Shin-Etsu Chemical Co., Ltd.)
Methylethyl ketone (MEK): 2.5 parts by mass
Toluene: 2.5 parts by mass

### Example 1-2

A thermal transfer image-receiving sheet was produced in the same manner as in Example 1-1 except that the paper substrate A was changed to a paper substrate B (NEVIA; manufactured by GOLD EAST PAPER (JIANGSU) CO., LTD; having a basis weight of 130 g/m²) having a thickness of 107 μm.

### Example 1-3

A thermal transfer image-receiving sheet was produced in the same manner as in Example 1-1 except that the paper substrate A was changed to a paper substrate C (NEVIA; manufactured by GOLD EAST PAPER (JIANGSU) CO., LTD; having a basis weight of 135 g/m²) having a thickness of 115 μm.

### Example 1-4

A thermal transfer image-receiving sheet was produced in the same manner as in Example 1-1 except that the paper substrate A was changed to a paper substrate D (NEVIA; manufactured by GOLD EAST PAPER (JIANGSU) CO., LTD; having a basis weight of 140 g/m²) having a thickness of 121 μm.

### Example 1-5

A thermal transfer image-receiving sheet was produced in the same manner as in Example 1-1 except that the paper substrate A was changed to a paper substrate E (NEVIA; manufactured by GOLD EAST PAPER (JIANGSU) CO., LTD; having a basis weight of 150 g/m²) having a thickness of 129 μm.

### Example 1-6

A thermal transfer image-receiving sheet was produced in the same manner as in Example 1-1 except that the paper substrate A was changed to the paper substrate C, that the weight and thickness of the second resin layer were changed to 34 g/m² and 36 μm respectively, and that the weight and thickness of the first resin layer were changed to 28 g/m² and 31 μm respectively.

### Example 1-7

A thermal transfer image-receiving sheet was produced in the same manner as in Example 1-1 except that the paper substrate A was changed to the paper substrate C, that the weight and thickness of the first resin layer were changed to 34 g/m² and 36 μm respectively, that the first resin layer was formed using a resin composition C comprising only the above-mentioned polypropylene, and that the weight and thickness of the first resin layer were changed to 28 g/m² and 31 μm respectively.

### Example 1-8

A thermal transfer image-receiving sheet was produced in the same manner as in Example 1-1 except that the paper substrate A was changed to the paper substrate C, that the weight and thickness of the second resin layer were changed to 18 g/m² and 19 μm respectively, that the first resin layer was formed using a resin composition D obtained by mixing the above-mentioned polypropylene and the above-mentioned styrene-ethylene-butene-styrene copolymer at a ratio of 95:5, and that the weight and thickness of the first resin layer were changed to 62 g/m² and 69 μm respectively.

### Example 1-9

The resin composition A was melt-extruded on one face of the paper substrate C to form a first resin layer having a weight of 26 g/m² and a thickness of 28 μm.

A coating liquid that has the following composition and is used to form an adhesive layer was applied to the other face of the paper substrate C so as to have a thickness of 5 μm when dried. The coating liquid was dried to form the adhesive layer, and a porous stretched polypropylene film (SP-U; manufactured by Mitsui Chemicals Tohcello, Inc.; having a weight of 23.75 g/m²) having a thickness of 35 μm was laminated with the adhesive layer in between.

<Coating liquid for forming adhesive layer>
Polyurethane: 45 parts by mass
   (TAKELAC (registered trademark) A-969V; manufactured by Mitsui Chemicals, Inc.)
Isocyanate compound: 15 parts by mass
   (TAKENATE (registered trademark) A-51; manufactured by Mitsui Chemicals, Inc.)
Ethyl acetate: 45 parts by mass

In the same manner as in Example 1-1, a coating liquid for forming an intermediate layer and a coating liquid for forming a receiving layer were applied to the porous stretched polypropylene film, and dried to obtain a thermal transfer image-receiving sheet.

### Example 1-10

A thermal transfer image-receiving sheet was produced in the same manner as in Example 1-1 except that the paper substrate A was changed to the paper substrate C, that the weight and thickness of the first resin layer were changed to 18 g/m² and 19 μm respectively, that the first resin layer was formed using a resin composition E obtained by mixing the above-mentioned polypropylene and a polypropylene elastomer (TAFMER (registered trademark) PN-3560; manufactured by Mitsui Chemicals, Inc.) at a ratio of 8:2, and that the weight and thickness of the first resin layer were changed to 45 g/m² and 50 μm respectively.

### Example 1-11

A thermal transfer image-receiving sheet was produced in the same manner as in Example 1-10 except that the resin composition E was changed to a resin composition F obtained by mixing the above-mentioned polypropylene and the polypropylene elastomer at a ratio of 5:5.

<<Measurement of amount of curl>>

The thermal transfer image-receiving sheet produced in each of Examples and Comparative Examples was cut into a test piece having a width of 152 mm;

the test piece was wound up with the receiving layer facing outward, and the wound-off end was taped down, to obtain a roll-shaped test piece having an outer diameter of 60 mm; and the roll-shaped test piece was left to stand in an environment at 35° C. and a relative humidity of 20% for 24 hours.

Here, the tape portion was provided wholly along the width direction of the test piece.

After the standing, the roll-shaped test piece was wound off and cut by 30 mm from the wound-off end, and a test piece was cut out so as to have a length of 203 mm from the cut end.

The thus obtained test piece having a width of 152 mm and a length of 203 mm was placed on a flat table, and the heights up to which the four corners were curled were measured. Specifically, a curl concave on the receiving layer side was placed on the flat table with the receiving layer side upward, or a curl convex on the receiving layer side was placed on the flat table with the receiving layer side downward, followed by measurement. The largest one of the heights up to which the four corners were curled was regarded as the amount of curl. The measurement results are listed in Table 1.

<<Evaluation of smoothness of image-printed item>>

The thermal transfer image-receiving sheet produced in each of Examples and Comparative Examples was cut into a test piece having a width of 152 mm;

the test piece was wound up with the receiving layer facing outward, and the wound-off end was taped down, to obtain a roll-shaped test piece having an outer diameter of 60 mm; and the roll-shaped test piece was left to stand in an environment at 35° C. and a relative humidity of 20% for 24 hours.

Here, the tape portion was provided wholly along the width direction of the test piece, and had a length of 10 mm.

After the standing, the roll-shaped test piece was wound off and cut by 30 mm from the wound-off end.

Next, the roll-shaped piece was set in a thermal transfer printer (CP-D70D; manufactured by Mitsubishi Electric Corporation; set to the gloss mode); using a genuine ribbon of the thermal transfer printer, a solid white image was formed on the receiving layer of the roll-shaped test piece so as to have a size 152 mm in width and 203 mm in length from the cut end of the test piece; and thus, an image-printed item was obtained.

The obtained image-printed item was placed on a flat table, and the heights up to which the four corners were curled were measured. Specifically, a curl concave on the receiving layer side was placed on the flat table with the receiving layer side upward, or a curl convex on the receiving layer side was placed on the flat table with the receiving layer side downward, followed by measurement. The largest one of the heights up to which the four corners were curled was regarded as the amount of curl, and rated on the basis of the following rating criteria. The evaluation results are listed in Table 1.

(Rating criteria)

A: The amount of curl was less than 3 mm.

B: The amount of curl was 3 mm or more and less than 5 mm.

NG1: The amount of curl was 5 mm or more and less than 10 mm.

NG2: The amount of curl was 10 mm or more.

<<Evaluation of standing curl preventiveness>>

The thermal transfer image-receiving sheet produced in each of Examples and Comparative Examples was cut into a test piece having a width of 152 mm; and

the test piece was wound up with the receiving layer facing outward, and the wound-off end was taped down, to obtain a roll-shaped test piece having an outer diameter of 60 mm.

Next, the roll-shaped test piece was wound off and cut by 30 mm from the wound-off end; the roll-shaped test piece was set in a thermal transfer printer (CP-D70D; manufactured by Mitsubishi Electric Corporation; set to the gloss mode); using a genuine ribbon of the thermal transfer printer, a solid white image was formed on the receiving layer of the roll-shaped test piece so as to have a size 152 mm in width and 203 mm in length from the cut end of the test piece; and thus, an image-printed item was obtained.

Here, the image was formed under conditions at 23° C. and a relative humidity of 50%.

The obtained image-printed item was placed on a flat table, and the heights up to which the four corners were curled were measured and regarded as the amount of ante-standing curl.

Specifically, a curl concave on the receiving layer side was placed on the flat table with the receiving layer side upward, and a curl convex on the receiving layer side was placed on the flat table with the receiving layer side downward, followed by measurement. The amount of curl was 1 mm in all Examples and Comparative Examples.

Next, the image-printed item was left to stand in a high-humidity environment at 25° C. and a relative humidity of 65% for three days. After the standing, the image-printed item was placed on a flat table, and the heights up to which the four corners were curled were measured. The largest one of the heights up to which the four corners were curled was regarded as the amount of high-humidity environment post-standing curl, and rated on the basis of the following rating criteria. The evaluation results and the values are listed in Table 1.

In addition, an image-printed item was produced and left to stand in an environment changed to a low-humidity environment at 35° C. and a relative humidity of 20%; the low-humidity environment standing curl of the image-printed item was measured and rated in the same manner as above-mentioned; and the evaluation results and values are listed in Table 1.

(Rating criteria)

A: The amount of curl was less than 5 mm.

B: The amount of curl was 5 mm or more and less than 10 mm.

C: The amount of curl was 10 mm or more and less than 15 mm.

D: The amount of curl was 15 mm or more.

<<Evaluation of printing nonuniformity preventiveness>>

The thermal transfer image-receiving sheet produced in each of Examples and Comparative Examples was set in the thermal transfer printer (CP-D70D; manufactured by Mitsubishi Electric Corporation); using a genuine ribbon, a solid half-grey image (having an image gradation of 128/255) was formed on the receiving layer of the thermal transfer image-receiving sheet; thus, an image-printed item was obtained. The obtained image-printed item was visually observed and rated on the basis of the following rating criteria. The evaluation results are listed in Table 1.

(Rating criteria)

A: No nonuniformity was observed.

B: Nonuniformity was observed to a light degree but to a practically unproblematic degree.

C: Some nonuniformity was observed.

TABLE 1

| | | | | | | | | | | | Performance Evaluation | | | | |
|---|---|---|---|---|---|---|---|---|---|---|---|---|---|---|---|
| | | | | | | | | | | | Smoothness | | Standing Curl | | Print- |
| | Constituents of First Resin Layer | | | | | | | | | | of Image- | | Preventiveness | | ing |
| | | Amount | | | | | | Constituents | | | printed | | Temper- | Temper- | Non- |
| | | of | | | | Constituents | | of Second | | | Item | | ature: | ature: | uni- |
| | | Thermo- | | | Ten- | of Paper | | Resin | | A- | A- | | 25° C., | 35° C., | formity |
| | | plastic | | | sile | Substrate | | Layer | | mount | mount | | Relative | Relative | Pre- |
| | Classi- | Elas- | | Thick- | Mod- | Thick- | Basis | | Thick- | of | of | | Humid- | Humid- | ven- |
| | fi- | tomer | Weight | ness | ulus | ness | Weight | Weight | ness | Curl | Curl | | ity: | ity: | tive- |
| | cation | (mass %) | (g/m²) | (μm) | (MPa) | (μm) | (g/m²) | (g/m²) | (μm) | (mm) | (mm) | Rating | 65% | 20% | ness |
| Exam- | Non- | 20 | 45 | 50 | 900 | 98 | 120 | 26 | 28 | 9 | 1.5 | A | D | C | A |
| ple | porous | | | | | | | | | | | | | | |
| 1-1 | Layer | | | | | | | | | | | | | | |
| Exam- | Non- | 20 | 45 | 50 | 900 | 107 | 130 | 26 | 28 | 12 | 2.5 | A | C | C | A |
| ple | porous | | | | | | | | | | | | | | |
| 1-2 | Layer | | | | | | | | | | | | | | |
| Exam- | Non- | 20 | 45 | 50 | 900 | 115 | 135 | 26 | 28 | 14 | 3 | B | A | A | A |
| ple | porous | | | | | | | | | | | | | | |
| 1-3 | Layer | | | | | | | | | | | | | | |
| Exam- | Non- | 20 | 45 | 50 | 900 | 121 | 140 | 26 | 28 | 15 | 3.5 | B | A | A | A |
| ple | porous | | | | | | | | | | | | | | |
| 1-4 | Layer | | | | | | | | | | | | | | |
| Exam- | Non- | 20 | 45 | 50 | 900 | 129 | 150 | 26 | 28 | 18 | 4.5 | B | A | A | A |
| ple | porous | | | | | | | | | | | | | | |
| 1-5 | Layer | | | | | | | | | | | | | | |
| Exam- | Non- | 20 | 28 | 31 | 900 | 115 | 135 | 34 | 36 | 16 | 4.5 | B | B | C | A |
| ple | porous | | | | | | | | | | | | | | |
| 1-6 | Layer | | | | | | | | | | | | | | |
| Exam- | Non- | 0 | 28 | 31 | 1200 | 115 | 135 | 34 | 36 | 14 | 3.5 | B | B | C | B |
| ple | porous | | | | | | | | | | | | | | |
| 1-7 | Layer | | | | | | | | | | | | | | |
| Exam- | Non- | 5 | 62 | 69 | 1050 | 115 | 135 | 18 | 19 | 12 | 3 | B | C | B | B |
| ple | porous | | | | | | | | | | | | | | |
| 1-8 | Layer | | | | | | | | | | | | | | |
| Exam- | Porous | 0 | 23.75 | 35 | 1350 | 115 | 135 | 18 | 19 | 15 | 3 | B | D | C | A |
| ple | Layer | | | | | | | | | | | | | | |
| 1-9 | | | | | | | | | | | | | | | |
| Exam- | Non- | 20 | 45 | 50 | 970 | 115 | 135 | 18 | 19 | 12 | 3 | B | C | B | B |
| ple | porous | | | | | | | | | | | | | | |
| 1-10 | Layer | | | | | | | | | | | | | | |
| Exam- | Non- | 50 | 45 | 50 | 625 | 115 | 135 | 18 | 19 | 5 | 2 | A | C | B | A |
| ple | porous | | | | | | | | | | | | | | |
| 1-11 | Layer | | | | | | | | | | | | | | |

### Example 2-1

The polypropylene was melt-extruded on one face of high-quality paper A (having a smoothness of 290 seconds) having a thickness of 156 μm to form a first extrusion polyolefin layer having a thickness of 15 μm.

The thermal conductivity of this first extrusion polyolefin layer was 0.12 W/m·K as measured in accordance with ASTM C 177-04.

A coating liquid used to form a receiving layer in the above-mentioned Example 1-1 was applied to the first polyolefin layer and dried to form a receiving layer having a thickness of 2.5 μm.

The polypropylene was melt-extruded on the other face of the high-quality paper A to form a second extrusion polyolefin layer having a thickness of 15 μm, and thus, a thermal transfer image-receiving sheet was obtained.

### Example 2-2

A thermal transfer image-receiving sheet was produced in the same manner as in Example 2-1 except that the high-quality paper A was changed to coated paper A (having a smoothness of 3697 seconds) having a thickness of 130 μm.

### Example 2-3

A thermal transfer image-receiving sheet was produced in the same manner as in Example 2-1 except that the high-quality paper A was changed to coated paper B (having a smoothness of 5017 seconds) having a thickness of 130 μm.

### Example 2-4

A thermal transfer image-receiving sheet was produced in the same manner as in Example 2-3 except that the thickness of the first extrusion polyolefin layer was changed to 10 μm.

### Example 2-5

A thermal transfer image-receiving sheet was produced in the same manner as in Example 2-3 except that the thickness of the first extrusion polyolefin layer was changed to 40 μm.

### Example 2-6

A thermal transfer image-receiving sheet was produced in the same manner as in Example 2-3 except that the thickness of the first extrusion polyolefin layer was changed to 50 μm.

### Example 2-7

A thermal transfer image-receiving sheet was produced in the same manner as in Example 2-1 except that a mixture of polypropylene and low-density polyethylene (having a density of 0.938 g/cm3) (polypropylene:low-density polyethylene=7:3) was used to form a first extrusion polyolefin layer. The thermal conductivity of this first extrusion polyolefin layer was measured and found to be 0.18 W/m·K.

### Example 2-8

A thermal transfer image-receiving sheet was produced in the same manner as in Example 2-1 except that a mixture of polypropylene and high-density polyethylene (having a density of 0.949 g/cm3) (polypropylene:high-density polyethylene=7:3) was used to form a first extrusion polyolefin layer. The thermal conductivity of this first extrusion polyolefin layer was measured and found to be 0.23 W/m·K.

### Example 2-9

A thermal transfer image-receiving sheet was produced in the same manner as in Example 2-1 except that a mixture of polypropylene and the above-mentioned styrene-ethylene-butene-styrene copolymer (polypropylene:styrene-ethylene-butene-styrene copolymer=8:2) was used to form a first extrusion polyolefin layer. The thermal conductivity of this first extrusion polyolefin layer was measured and found to be 0.14 W/m·K.

### Example 2-10

A thermal transfer image-receiving sheet was produced in the same manner as in Example 2-2 except that a mixture of polypropylene and the above-mentioned styrene-ethylene-butene-styrene copolymer (polypropylene:styrene-ethylene-butene-styrene copolymer=8:2) was used to form a first extrusion polyolefin layer.

### Comparative Example 2-1

Low-density polyethylene (having a density of 0.918 g/cm³) was melt-extruded on one face of the high-quality paper A to form a first extrusion polyolefin layer having a thickness of 15 μm. The thermal conductivity of this first extrusion polyolefin layer was measured and found to be 0.33 W/m·K.

The above-mentioned coating liquid for forming a receiving layer was applied to the first extrusion polyolefin layer and dried to form a receiving layer having a thickness of 2.5 μm.

The polypropylene was melt-extruded on the other face of the high-quality paper A to form a second extrusion polyolefin layer having a thickness of 15 μm, and thus, a thermal transfer image-receiving sheet was obtained.

### Comparative Example 2-2

A thermal transfer image-receiving sheet was produced in the same manner as in Comparative Example 2-1 except that the high-quality paper A was changed to high-quality paper B (having a smoothness of 13 seconds) having a thickness of 75 μm.

### Comparative Example 2-3

A thermal transfer image-receiving sheet was produced in the same manner as in Comparative Example 2-2 except that the thickness of the first extrusion polyolefin layer was changed to 40 μm.

### Comparative Example 2-4

A thermal transfer image-receiving sheet was produced in the same manner as in Comparative Example 2-1 except that the high-quality paper A was changed to high-quality paper C (having a smoothness of 57 seconds) having a thickness of 140 μm.

### Comparative Example 2-5

A thermal transfer image-receiving sheet was produced in the same manner as in Comparative Example 2-1 except that the high-quality paper A was changed to the coated paper A.

### Comparative Example 2-6

A thermal transfer image-receiving sheet was produced in the same manner as in Comparative Example 2-1 except that the high-quality paper A was changed to the coated paper B.

### Comparative Example 2-7

High-density polyethylene (having a density of 0.956 g/cm³) was melt-extruded on one face of the high-quality paper A to form a first extrusion polyolefin layer having a thickness of 15 μm. The thermal conductivity of this first extrusion polyolefin layer was measured and found to be 0.49 W/m·K.

The above-mentioned coating liquid for forming a receiving layer was applied to the first extrusion polyolefin layer and dried to form a receiving layer having a thickness of 2.5 μm.

The polypropylene was melt-extruded on the other face of the high-quality paper A to form a second extrusion polyolefin layer having a thickness of 15 μm, and thus, a thermal transfer image-receiving sheet was obtained.

### Comparative Example 2-8

A thermal transfer image-receiving sheet was produced in the same manner as in Comparative Example 2-7 except that a mixture of polypropylene and low-density polyethylene (having a density of 0.929 g/cm³) (polypropylene:low-density polyethylene=4:6) was used to form a first extrusion polyolefin layer. The thermal conductivity of this first extrusion polyolefin layer was measured and found to be 0.26 W/m·K.

### Comparative Example 2-9

A thermal transfer image-receiving sheet was produced in the same manner as in Comparative Example 2-7 except that a mixture of polypropylene and low-density polyethylene (having a density of 0.926 g/cm³) (polypropylene:low-density polyethylene=3:7) was used to form a first extrusion polyolefin layer. The thermal conductivity of this first extrusion polyolefin layer was measured and found to be 0.27 W/m·K.

### Comparative Example 2-10

Low-density polyethylene (having a density of 0.918 g/cm³) was melt-extruded on one face of the high-quality paper A to form a first extrusion polyolefin layer having a thickness of 15 μm, and a stretched polypropylene film (HO402; manufactured by Hwaseung Chemical Co., Ltd.; having a thermal conductivity of 0.12 W/m·K) having a thickness of 18 μm was laminated with the first extrusion polyolefin layer in between.

A coating liquid for forming a receiving layer was applied to the stretched polypropylene film and dried to form a receiving layer having a thickness of 2.5 μm.

The polypropylene was melt-extruded on the other face of the high-quality paper A to form a second extrusion polyolefin layer having a thickness of 15 μm, and thus, a thermal transfer image-receiving sheet was obtained.

### Comparative Example 2-11

A coating liquid that has the following composition and is used to form an adhesive layer was applied on one face of the high-quality paper A; a stretched polypropylene film (HO402; manufactured by Hwaseung Chemical Co., Ltd.; having a thermal conductivity of 0.12 W/m·K) having a thickness of 18 μm was adhered onto the coating liquid; and the resulting sheet was dried. Here, the adhesive layer had a thickness of 5 μm when dried.

<Coating liquid for forming adhesive layer>
Polyurethane: 45 parts by mass
   (TAKELAC (registered trademark) A-969V; manufactured by Mitsui Chemicals, Inc.)
Isocyanate compound: 15 parts by mass
   (TAKENATE (registered trademark) A-51; manufactured by Mitsui Chemicals, Inc.)
Ethyl acetate: 45 parts by mass

A coating liquid for forming a receiving layer was applied to the stretched polypropylene film and dried to form a receiving layer having a thickness of 2.5 μm.

The polypropylene was melt-extruded on the other face of the high-quality paper A to form a second extrusion polyolefin layer having a thickness of 15 μm, and thus, a thermal transfer image-receiving sheet was obtained.

### Comparative Example 2-12

A thermal transfer image-receiving sheet was obtained in the same manner as in Comparative Example 2-10 except that the stretched polypropylene film was changed to a porous polypropylene film (SP-U;

manufactured by Mitsui Chemicals Tohcello, Inc.) having a thickness of 35 μm.

### Comparative Example 2-13

Low-density polyethylene (having a density of 0.918 g/cm³) was melt-extruded on one face of the high-quality paper B to form a first extrusion polyolefin layer having a thickness of 15 μm, and a porous polypropylene film (SP-U; manufactured by Mitsui Chemicals Tohcello, Inc.) having a thickness of 35 μm was laminated with the first extrusion polyolefin layer in between.

A coating liquid for forming a receiving layer was applied to the porous polypropylene film and dried to form a receiving layer having a thickness of 2.5 μm.

Low-density polyethylene (having a density of 0.918 g/cm³) was melt-extruded on the other face of the high-quality paper B to form a second extrusion polyolefin layer having a thickness of 15 μm, and thus, a thermal transfer image-receiving sheet was obtained.

The thermal transfer image-receiving sheet produced in each of Examples and Comparative Examples was subjected to the following tests for evaluation.

<<Evaluation of image density>>

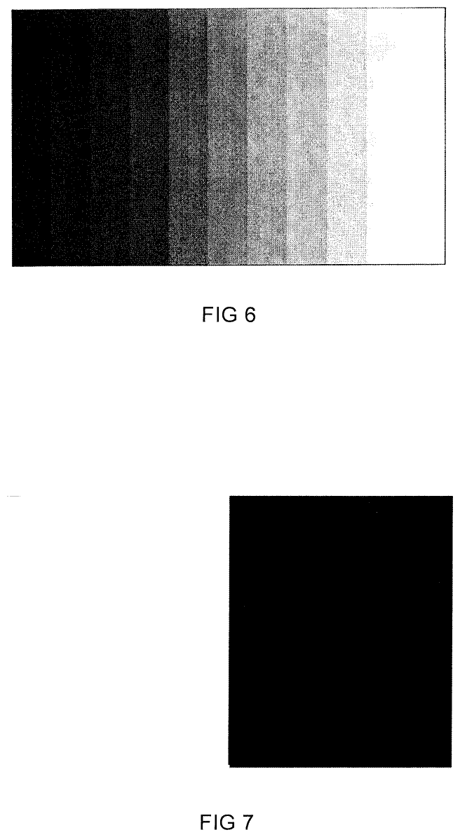

Using a sublimation type thermal transfer printer (DS-RX1, manufactured by Dai Nippon Printing Co., Ltd.) and a genuine thermal transfer sheet (manufactured by Dai Nippon Printing Co., Ltd.) for the printer, an 11-STEP image such as shown in FIG. 6 was formed on the receiving layer of the thermal transfer image-receiving sheet obtained in each Example and Comparative Example to produce an image-printed item (102 mm×152 mm). Here, the 11-STEP image is an image having 11 gradated steps of density ranging from white to black.

The density of the 11th step of the formed 11-STEP image was measured using an optical densitometer (i1-pro2, manufactured by X-Rite Inc., in accordance with Ansi-A, having a D65 light source, at a measurement angle of 2°, and having no filter). An image density ratio to the density of an image formed using the thermal transfer image-receiving sheet in Comparative Example 13 (hereinafter, simply referred to as an image density ratio) was calculated (the density of an image formed using a thermal transfer image-receiving sheet other than produced in Comparative Example 2-13/the density of an image formed using the thermal transfer image-receiving sheet in Comparative Example 2-13×100), and the image density was rated on the basis of the following rating criteria. The evaluation results are listed in Table 2.

(Rating criteria)

A: The image density ratio was 100% or more, and made it possible to verify a very high image density.

B: The image density ratio was 85% or more and less than 100%, and made it possible to verify a high image density.

NG1: The image density ratio was 75% or more and less than 85%, and was practically problematic.

NG2: The image density ratio was 65% or more and less than 75%, and was practically problematic.

NG3: The image density ratio was less than 65%.

<<Evaluation of printing nonuniformity preventiveness>>

The 6th step (having an image gradation of 128/255) of the 11-STEP image produced as above-mentioned was visually observed, and the printing nonuniformity preventiveness was rated on the basis of the following rating criteria. The evaluation results are listed in Table 2.

(Rating criteria)

A: No printing nonuniformity was generated.

B: Printing nonuniformity was generated to a light degree but to a practically unproblematic degree.

NG: Some printing nonuniformity was generated, and it was practically problematic.

<<Evaluation of winding-caused-wrinkle preventiveness>>

The thermal transfer image-receiving sheet obtained in each of Examples and Comparative Examples was cut so as to be 75 mm×25 mm, wound around a core having a diameter of 20 with the receiving layer side facing outward, and stored in an environment at 20° C. and 65% (relative humidity) for two weeks. The surface of the receiving layer side of the image-printed item after the storage was visually observed, and the winding-caused-wrinkle generation preventiveness was rated on the basis of the following rating criteria. The evaluation results are listed in Table 2.

(Evaluation results)

A: No wrinkle was observed on the surface of the receiving layer side.

NG: Some wrinkles were observed on the surface of the receiving layer side.

<<Evaluation of embossment preventiveness>>

Using a sublimation type thermal transfer printer (DS-RX1, manufactured by Dai Nippon Printing Co., Ltd.) and a genuine thermal transfer sheet (manufactured by Dai Nippon Printing Co., Ltd.) for the printer, a half-black pattern image such as shown in FIG. 7 was formed on the receiving layer of the thermal transfer image-receiving sheet obtained in each Example and Comparative Example. The boundary between the solid black portion (having an image gradation of 0/255) and the solid white portion (having an image gradation of 255/255) in the formed half-black pattern image was visually observed, and the embossment generation preventiveness was rated on the basis of the following rating criteria. The evaluation results are listed in Table 2.

(Rating criteria)

A: No formation of steps and/or roughness was observed.

B: A little formation of steps and/or roughness was observed, but it was practically unproblematic.

NG: Some formation of steps and/or roughness was observed, and the appearance was significantly impaired.

<<Evaluation of smoothness of image-printed item>>

An image-printed item obtained in the evaluation of image density was stored in an environment at 20° C. and 65% (relative humidity) for two weeks.

The image-printed item was placed on a flat table with the receiving layer side upward, and the heights up to which the four corners were curled were measured. The largest one of the heights up to which the four corners were curled was regarded as the amount of image-printed item curl, and the generation preventiveness of the image-printed item curl (a curl concave on the receiving layer side) was rated on the basis of the following rating criteria. The evaluation results are listed in Table 2.

(Rating criteria)

A: The amount of image-printed item curl was less than 10 mm and verified that the image-printed item had favorable smoothness.

B: The amount of image-printed item curl was 10 mm or more and less than 20 mm and was practically unproblematic.

NG: The amount of image-printed item curl was 20 mm or more and was practically problematic.

TABLE 2

| | | | | | | Whether | | | | | |
|---|---|---|---|---|---|---|---|---|---|---|---|
| | | | | | | resin | Performance Evaluation of Thermal | | | | |
| | | | | | | film is | Transfer Image-receiving Sheet | | | | |
| | | | | | | laminated | | | | | Smooth- |
| | First Extrusion Polyolefin Layer | | | | | on | | Printing | Winding- | Emboss- | ness |
| | | Thermal | | Substrate | | first | | Non- | caused | ment | of |
| | Constituent | Con- | Thick- | | Smooth- | extrusion | | uniformity | Wrinkle | Pre- | Image- |
| | Resin | ductivity | ness | | ness | polyolefin | Image | Preventive- | Preventive- | ventive- | printed |
| | Material | (W/m · K) | (μm) | Type | (seconds) | layer | Density | ness | ness | ness | Item |
| Example 2-1 | Polypropylene | 0.12 | 15 | High-quality | 290 | No | B | B | A | A | B |
| | | | | Paper | | | | | | | |
| Example 2-2 | Polypropylene | 0.12 | 15 | Coated paper | 3697 | No | B | B | A | A | A |
| Example 2-3 | Polypropylene | 0.12 | 15 | Coated paper | 5017 | No | B | B | A | A | A |
| Example 2-4 | Polypropylene | 0.12 | 10 | Coated paper | 5017 | No | B | B | A | A | A |
| Example 2-5 | Polypropylene | 0.12 | 40 | Coated paper | 5017 | No | B | A | A | A | A |
| Example 2-6 | Polypropylene | 0.12 | 50 | Coated paper | 5017 | No | B | A | A | B | A |
| Example 2-7 | Polypropylene: | 0.18 | 15 | High-quality | 290 | No | B | B | A | A | B |
| | Low-density | | | Paper | | | | | | | |
| | Polyethylene (7:3) | | | | | | | | | | |
| Example 2-8 | Polypropylene: | 0.23 | 15 | High-quality | 290 | No | B | B | A | A | B |
| | High-density | | | Paper | | | | | | | |
| | Polyethylene (7:3) | | | | | | | | | | |
| Example 2-9 | Polypropylene: | 0.14 | 15 | High-quality | 290 | No | B | B | A | A | B |
| | Styrene-Ethylene- | | | Paper | | | | | | | |
| | Butene-Styrene | | | | | | | | | | |
| | Copolymer (8:2) | | | | | | | | | | |
| Example 2-10 | Polypropylene: | 0.14 | 15 | Coated paper | 3697 | No | B | B | A | A | A |
| | Styrene-Ethylene- | | | | | | | | | | |
| | Butene-Styrene | | | | | | | | | | |
| | Copolymer (8:2) | | | | | | | | | | |
| Comparative | Low-density | 0.33 | 15 | High-quality | 290 | No | NG2 | NG | A | A | B |
| Example 2-1 | Polyethylene | | | Paper | | | | | | | |
| Comparative | Low-density | 0.33 | 15 | High-quality | 13 | No | NG2 | NG | A | A | B |
| Example 2-2 | Polyethylene | | | Paper | | | | | | | |
| Comparative | Low-density | 0.33 | 40 | High-quality | 13 | No | NG2 | NG | A | A | B |
| Example 2-3 | Polyethylene | | | Paper | | | | | | | |
| Comparative | Low-density | 0.33 | 15 | High-quality | 57 | No | NG2 | NG | A | A | B |
| Example 2-4 | Polyethylene | | | Paper | | | | | | | |
| Comparative | Low-density | 0.33 | 15 | Coated paper | 3697 | No | NG2 | B | A | A | A |
| Example 2-5 | Polyethylene | | | | | | | | | | |
| Comparative | Low-density | 0.33 | 15 | Coated paper | 5017 | No | NG2 | B | A | A | A |
| Example 2-6 | Polyethylene | | | | | | | | | | |
| Comparative | High-density | 0.49 | 15 | High-quality | 290 | No | NG3 | B | A | A | B |
| Example 2-7 | Polyethylene | | | Paper | | | | | | | |
| Comparative | Polypropylene: | 0.26 | 15 | High-quality | 290 | No | NG1 | B | A | A | B |
| Example 2-8 | Low-density | | | Paper | | | | | | | |
| | Polyethylene (4:6) | | | | | | | | | | |
| Comparative | Polypropylene: | 0.27 | 15 | High-quality | 290 | No | NG1 | B | A | A | B |
| Example 2-9 | Low-density | | | Paper | | | | | | | |
| | Polyethylene (3:7) | | | | | | | | | | |
| Comparative | Low-density | 0.33 | 15 | High-quality | 290 | Yes | B | B | A | A | NG |
| Example 2-10 | Polyethylene | | | Paper | | (Stretched | | | | | |
| | | | | | | Polypropylene | | | | | |
| | | | | | | Film) | | | | | |
| Comparative | — | — | — | High-quality | 290 | Yes | B | B | A | A | NG |
| Example 2-11 | | | | Paper | | (Stretched | | | | | |
| | | | | | | Polypropylene | | | | | |
| | | | | | | Film) | | | | | |
| Comparative | Low-density | 0.33 | 15 | High-quality | 290 | Yes | A | B | NG | NG | NG |
| Example 2-12 | Polyethylene | | | Paper | | (Porous | | | | | |
| | | | | | | Polypropylene | | | | | |
| | | | | | | Film) | | | | | |
| Comparative | Low-density | 0.33 | 15 | High-quality | 13 | Yes | — | A | NG | NG | NG |
| Example 2-13 | Polyethylene | | | Paper | | (Porous | | | | | |
| | | | | | | Polypropylene | | | | | |
| | | | | | | Film) | | | | | |

### REFERENCE SIGNS LIST

10: Thermal transfer image-receiving sheet, 11: Receiving layer, 12: First resin layer, 13: Paper substrate, 14: Second resin layer, A: Cut test piece, 20: Thermal transfer image-receiving sheet, 21: Receiving layer, 22: First extrusion polyolefin layer, 23: Substrate, 24: Second extrusion polyolefin layer

1. A thermal transfer image-receiving sheet comprising a receiving layer, a first resin layer, a paper substrate, and a second resin layer in this order,
wherein the paper substrate has a thickness of 95 μm or more and 135 μm or less,
the first resin layer has a weight of 20 g/m² or more and 60 g/m² or less, and
the second resin layer has a weight of 19 g/m² or more and 35 g/m² or less.

2. A thermal transfer image-receiving sheet comprising a receiving layer, a first resin layer, a paper substrate, and a second resin layer in this order,
wherein the paper substrate has a thickness of 95 μm or more and 135 μm or less, and
wherein, from the thermal transfer image-receiving sheet,
(1) a test piece having a width of 152 mm is produced,
(2) the test piece is wound up with the receiving layer facing outward, and the wound-off end is taped down, to obtain a roll-shaped test piece having an outer diameter of 60 mm,
(3) the roll-shaped test piece is left to stand in an environment at 35° C. and a relative humidity of 20% for 24 hours,
(4) the roll-shaped test piece is cut by 30 mm from the wound-off end, and
(5) a test piece cut out to have a length of 203 mm from the cut end has a curl, the amount of which is less than 20 mm.

3. The thermal transfer image-receiving sheet according to claim 2,
wherein, from the thermal transfer image-receiving sheet,
(1) a test piece having a width of 152 mm is produced,
(2) the test piece is wound up with the receiving layer facing outward, and the wound-off end is taped down, to obtain a roll-shaped test piece having an outer diameter of 60 mm,
(3) the roll-shaped test piece is left to stand in an environment at 35° C. and a relative humidity of 20% for 24 hours,
(4) the roll-shaped test piece is cut by 30 mm from the wound-off end, and
(5) an image is formed on the receiving layer of the roll-shaped test piece to produce an image-printed item having a size 152 mm in width and 203 mm in length from the cut end, and the amount of a curl of the produced image-printed item is less than 5 mm.

4. The thermal transfer image-receiving sheet according to claim 1, wherein the paper substrate has a thickness of 110 μm or more and 130 μm or less.

5. The thermal transfer image-receiving sheet according to claim 1, wherein the first resin layer has a tensile modulus of 800 MPa or more and 1000 MPa or less.

6. The thermal transfer image-receiving sheet according to claim 1, wherein the first resin layer is a non-porous layer.

7. The thermal transfer image-receiving sheet according to claim 1, wherein the first resin layer comprises a thermoplastic elastomer, the amount of which is 5 mass % or more and 50 mass % or less.

8. A thermal transfer image-receiving sheet comprising a receiving layer, a first extrusion polyolefin layer, and a substrate,
wherein the substrate has a smoothness of 250 seconds or more, and
the first extrusion polyolefin layer comprises 65 parts by mass or more of polypropylene with respect to 100 parts by mass of a resin material comprised in the first extrusion polyolefin layer.

9. A thermal transfer image-receiving sheet comprising a receiving layer, a first extrusion polyolefin layer, and a substrate,
wherein the substrate comprises at least coated paper, and
the first extrusion polyolefin layer comprises 65 parts by mass or more of polypropylene with respect to 100 parts by mass of a resin material comprised in the first extrusion polyolefin layer.

10. The thermal transfer image-receiving sheet according to claim 8, wherein the first extrusion polyolefin layer has a thermal conductivity of 0.25 W/m·K or less.

11. The thermal transfer image-receiving sheet according to claim 8, wherein the first extrusion polyolefin layer comprises a thermoplastic elastomer, the amount of which is 5 mass % or more and 50 mass % or less.
